(19) United States
(12) Patent Application Publication
(10) Pub. No.: US 2023/0036696 A1
(43) Pub. Date: Feb. 2, 2023

(54) PHOTOCURABLE COMPOSITION FOR THREE-DIMENSIONAL PRINTING

(71) Applicant: Momentive Performance Materials Inc., Waterford, NY (US)

(72) Inventors: Soumya SARKAR, Bangalore (IN); Vinu Krishnan APPUKUTTAN, Bengaluru (IN); Yogesh TIWARY, Bengaluru (IN); Debarshi DASGUPTA, Bangalore (IN)

(21) Appl. No.: 17/786,294

(22) PCT Filed: Dec. 21, 2020
(86) PCT No.: PCT/US2020/066326

§ 371 Date: Jun. 16, 2022

(30) Foreign Application Priority Data
Dec. 21, 2019 (IN) 201921053299

(51) Int. Cl. C09D 183/08; C08L 83/08; C09D 11/102; B33Y 70/00

(52) U.S. Cl. CPC C09D 183/08; C08L 83/08; C09D 11/102; B33Y 70/00

(57) ABSTRACT

Provided is a radiation curable silicone composition suitable for additive manufacturing processes, a process for making such compositions, and a method for forming an article from such compositions. The compositions exhibit fast radiation curing over a variety of wavelengths. The articles formed from the compositions exhibit a good balance of properties including flexibility and mechanical strength. In embodiments, the organo-silicone composition comprises at least one polymerization-effective silicone containing polymer bearing unsaturated hydrocarbon group, at least one mercapto functional silicone resin, and a photo initiator.

### CROSS REFERENCE TO RELATED APPLICATIONS

The present application claims priority to and the benefit of India Patent Registration Provisional Application 201921053299 filed on Dec. 21, 2019, the disclosure of which is incorporated by reference herein in its entirety.

### FIELD

The patent application relates to a composition comprising silicone materials, a process to manufacture such compositions, and the use of such compositions to form three-dimensional articles, such as, for example by three-dimensional printing.

### BACKGROUND

Molding is a traditional process of making elastomeric articles or devices as this technique is easy to handle and compatible with most of the polymeric materials available today. A major limitation of molding technology is lack of precision in complex designing of the articles, cleaning time, material waste, etc., along with the complexity and expense of having to make a mold for every different type of architecture.

Three-dimensional printing or additive manufacturing (AM) is a process of making three-dimensional objects. The objects can be made using digital files or images to print such articles with minimum material waste and high precision. So far, many organic or inorganic polymeric materials has been used for printing simple or complex designs, but the use of silicone material as three-dimensional printing material is limited. The difficulty in providing suitable silicone materials has been in finding materials that meet the needs of a low viscosity material that exhibits fast curing to be useful in such additive manufacturing processes and that provide a final product with desirable physical properties (e.g., flexibility, haptic feel, chemical resistance, etc.).

Stereolithography or digital light processing printers require highly specific photocurable materials in terms of viscosity, cure time, or modulus, and it is difficult to produce soft articles or devices using these printers. As mentioned above, there have been some attempts to make specific silicone formulations to be used in such printers, but still there is a need for a silicone containing three-dimensional printing material with desired mechanical properties and fast curing.

### SUMMARY

Provided is a radiation curable silicone composition suitable for additive manufacturing processes. The compositions exhibit fast radiation curing over a variety of wavelengths. The articles formed from the compositions exhibit a good balance of properties including flexibility and mechanical strength.

In one aspect, provided is an organo-silicone composition comprising at least one polymerization-effective silicone containing polymer bearing unsaturated hydrocarbon group, at least one mercapto functional silicone resin, and a photo initiator.

In another aspect, provided is a process to prepare an organo-silicone composition comprising at least one polymerization-effective silicone containing polymer bearing unsaturated hydrocarbon group, at least one mercapto functional silicone resin, and a photo initiator.

In yet another aspect, provided is a process to form a three-dimensional printed and a three-dimensional printed article prepared from an organo-silicone composition comprising at least one polymerization-effective silicone containing polymer bearing unsaturated hydrocarbon group, at least one mercapto functional silicone resin and a photo initiator.

In one aspect, provided is organo-silicone composition comprising:

a. 10 to 90 wt. %, based on the total weight of the composition, of at least one polymerization-effective silicone containing polymer bearing unsaturated hydrocarbon group;
b. 1 to 60 wt. %, based on the total weight of the composition, of at least one mercapto functional silicone resin of general formula (I);

M⁴ₖM⁵ₗD⁴ₘD⁵ₙT⁴ₒT⁵ₚQ¹ᵣ (I)

wherein, the M⁴ and M⁵ units are of the formula R²⁰R²¹R²²SiO_{1/2};

the D⁴ and D⁵ units are of the formula: R²³R²⁴SiO_{2/2};

the T⁴ and T⁵ units are of the formula: R²⁵SiO_{3/2};

the Q₁ units are of the formula SiO_{4/2};

R²⁰-R²³ are independently chosen from hydrogen, a hydroxyl, a linear or branched alkyl group, an alcohol, a linear or branched alkoxy group, an aryl group, an alkylvinyl group, an amide, an amino-containing group, an acryloyl-containing group, a methacryloyl-containing group, a carbonyl-containing group, a carboxylic acid-containing group, a silyloxy group, an isocyanate-containing group, a mercapto-containing group, an epoxy-containing group, where one or more of R²⁰-R²⁵ is a mercapto-containing group; k is from 0-1000, 1 is from 0-1000; m is from 0-500; n is from 0-500; o is from 0-100; p is from 0-100; and r is from 0 to 200, provided at least two subscripts on any particular embodiment are positive integers and at least one of o or p should be a positive integer; and c. a photo initiator;

wherein, the composition has a molar equivalent ratio of mercapto functional groups to unsaturated groups from 0.01 to 2.5.

In one embodiment, the molar equivalent ratio of mercapto functional groups to unsaturated groups is 0.1:1 to 2:1.

In one embodiment, the molar equivalent ratio of mercapto functional groups to unsaturated groups is 0.8 to 1.5:1.

In one embodiment of a composition in accordance with any other previous embodiment, the at least one polymerization-effective silicone containing polymer bearing unsaturated hydrocarbon group (b) is of general formula (II)

M¹ₐM²_{b}M³_{c}D¹_{d}D²ₑD³_{f}T¹_{g}T²ₕQⱼ (II)

wherein:
M¹=R¹R²R³SiO_{1/2}
M²=R⁴R⁵R⁶SiO_{1/2}
M³=R⁷R⁸R⁹SiO_{1/2}
D¹=R¹⁰R¹¹SiO_{2/2}
D²=R¹²R¹³SiO_{2/2}
D³=R¹⁴R¹⁵SiO_{2/2}
T¹=R¹⁶SiO_{3/2}
T²=R¹⁷SiO_{3/2}
T³=R¹⁸SiO_{3/2}
Q=SiO_{4/2}
   R¹ to R¹⁸ are independently selected from hydrogen, substituted or unsubstituted aliphatic, alicyclic, or aromatic containing hydrocarbon having from 1 to 60 carbon atoms optionally having a heteroatom, OR²⁶, or an unsaturated monovalent hydrocarbon optionally containing heteroatom(s) or a heteroatom such as oxygen, nitrogen, sulfur or containing organosilane groups; where R²⁶ is selected from hydrogen, substituted or unsubstituted aliphatic, alicyclic, or aromatic containing hydrocarbon having from 1 to 60 carbon; the subscript a, b, c, d, e, f, g, h, i, j are zero or positive integer provided 2≤a+b+c+d+e+f+g+h+i+j provided at least one R group is selected from unsaturated monovalent hydrocarbon or aromatic compound, having up to 60 carbon atoms optionally having a heteroatom or both

In one embodiment of a composition in accordance with any other previous embodiment, the photo initiator is selected from a benzophenone, a phosphine oxide, a nitroso compound, an acryl halide, a hydrazone, a mercapto compound, a pyrillium compound, a triacrylimidazole, a benzimidazole, a chloroalkyl triazine, a benzoin ether, a benzyl ketal, a thioxanthone, a camphorquinone, an acetophenone, an organometallic compound, a metallocene derivative, or a combination of two or more thereof.

In one embodiment of a composition in accordance with any other previous embodiment, the organo-silicone composition comprises a UV absorber, a UV enhancer, a photo inhibitor, a reactive or non-reactive diluent, an optical brightener, an adhesion promoter, a filler, a radical stabilizer, a diluent, a coupling agent, a coloring agent, an antifoaming agent, a defoaming agents, a leveling agent, or combination of two or more thereof.

In one embodiment of a composition in accordance with any other previous embodiment, the polymerization-effective silicone polymer (a) is present in an amount of from about 20% to 80% based on the total weight of the composition, and the mercapto functional silicone resin (b) is present in an amount of from about 5% to about 50% based on the total weight of the composition.

In one embodiment of a composition in accordance with any other previous embodiment, wherein the mercapto functional silicone resin (b) is a MDT resin where k+l is greater than 0, m+n is greater than 0, and o+p is greater than 0.

In one embodiment of a composition in accordance with any previous embodiment, the silicone resin (b) is a MDT resin of the formula:

[(R²⁰)(R²¹)(R²²)SiO_{1/2}]ₖ[(R²⁵)SiO_{3/2}]ₒ[R²³R²⁴O_{2/2}]ₘ

where R²⁰,R²¹, R²², R²³,and R²⁴ are as described above, R²⁵ is —(CH₂)ₜSH, where t is 1-10, and k, o, and m are positive integers. In one embodiment, R²⁰, R²¹, R²², R²³, and R²⁴ are each selected from a C1-C10 alkyl group, a C2-C8 alkyl group, or a C4-C6 alkyl group. In one embodiment, R²⁰, R²¹, R²², R²³, and R₂₄ are each methyl. In one embodiment k+o+m is from about 10 to about 300, from about 10 to about 200, or from about 10 to about 100.

In another aspect, provided is a process to prepare an organo-silicone composition comprising mixing:

a. 10 to 90 wt. %, based on the total weight of the composition, of at least one polymerization-effective silicone polymer bearing unsaturated hydrocarbon group;
b. 1 to 60 wt. %, based on the total weight of the composition, of at least one mercapto functional silicone resin of general formula (I);

M⁴ₖM⁵ₗD⁴ₘD⁵ₙT⁴ₒT⁵ₚQ¹ᵣ (I)
Wherein, the M⁴ and M⁵ units are of the formula R²⁰R²¹R²²SiO_{1/2};
the D⁴ and D⁵ units are of the formula: R²³R²⁴SiO_{2/2};
the T⁴ and T⁵ units are of the formula: R²⁵SiO_{3/2};
the Q¹units are of the formula SiO_{4/2};
R²⁰-R²⁵ are independently chosen from hydrogen, a hydroxyl, a linear or branched alkyl group, an alcohol, a linear or branched alkoxy group, an aryl group, an alkylvinyl group, an amide, an amino-containing group, an acryloyl-containing group, a methacryloyl-containing group, a carbonyl-containing group, a carboxylic acid-containing group, a silyloxy group, an isocyanate-containing group, a mercapto-containing group, an epoxy-containing group, where one or more of R²⁰—R²⁵ is a mercapto-containing group; k is from 0-1000,1 is from 0-1000; m is from 0-500; n is from 0-500; o is from 0-100; p is from 0-100; and r is from 0 to 200, provided at least two subscripts on any particular embodiment are positive integers and at least one of o or p should be a positive integer; and
c. a photo initiator; to form a composition,
wherein, the composition has a molar equivalent ratio of mercapto groups to unsaturated groups from 0.01 to 2.5.

In one embodiment of the process, the molar equivalent ratio of mercapto groups to unsaturated groups is 0.1:1 to 2:1.

In one embodiment of the process, the molar equivalent ratio of mercapto groups to unsaturated groups is 0.8 to 1.5:1.

In one embodiment of a process in accordance with any other previous embodiment, at least one polymerization-effective silicone polymer bearing unsaturated hydrocarbon group is of general formula (II)

M¹ₐM²_{b}M³_{c}D¹_{d}D²ₑD³_{f}T¹_{g}T²ₕT³ᵢQⱼ (II)

wherein:
M¹=R¹R²R³SiO_{1/2}
M²=R⁴R⁵R⁶SiO_{1/2}
M³=R⁷R⁸R⁹SiO_{1/2}
D¹=R¹⁰R¹¹R¹²SiO_{2/2}
D²=R¹²R¹²SiO_{2/2}
D³=R¹⁴R¹⁵SiO_{2/2}
T¹=R¹⁶SiO_{3/2}
T²=R¹⁷SiO_{3/2}
T³=R¹⁸SiO_{3/2}
Q=SiO_{4/12}
   R¹ to R¹⁸ are independently selected from hydrogen, substituted or unsubstituted aliphatic, alicyclic, or aromatic containing hydrocarbon having from 1 to 60 carbon atoms optionally having a heteroatom, OR²⁶, or an unsaturated monovalent hydrocarbon optionally containing heteroatom(s) or a heteroatom such as oxygen, nitrogen, sulfur or containing organosilane groups; where R²⁶ is selected from hydrogen, substituted or unsubstituted aliphatic, alicyclic, or aromatic containing hydrocarbon having from 1 to 60 carbon; the subscript a, b, c, d, e, f, g, h, i, j are zero or positive integer provided 2≤a+b+c+d+e+f+g+h+i+j provided at least one R group is selected from unsaturated monovalent hydrocarbon or aromatic compound, having up to 60 carbon atoms optionally having a heteroatom or both.

In one embodiment, the photo initiator is selected from a benzophenone, a phosphine oxide, a nitroso compound, an acryl halide, a hydrazone, a mercapto compound, a pyrillium compound, a triacrylimidazole, a benzimidazole, a chloroalkyl triazine, a benzoin ether, a benzyl ketal, a thioxanthone, a camphorquinone, an acetophenone, an organometallic compound, a metallocene derivative, or a combination of two or more thereof.

In one embodiment of a process in accordance with any other previous embodiment, the process comprises mixing one or more of a UV absorber, a UV enhancer, a photo inhibitor, a reactive or non-reactive diluent, an optical brightener, an adhesion promoter, a filler, a radical stabilizer, a diluent, a coupling agent, a coloring agent, an antifoaming agent, a defoaming agents, a leveling agent, or combination of two or more thereof with components (a)-(c).

In yet another aspect, provided is a three-dimensional printed article prepared from a composition or process according to any of the previous embodiments.

In one embodiment of preparing the three-dimensional printed article, the composition is polymerized using vat photopolymeriztion,binder jetting, or material jetting.

In one embodiment of preparing the three-dimensional printed article, the vat polymerization comprises exposing the composition to ultraviolet light of a wavelength of from 300 to 780 nm.

In one embodiment, the three-dimensional printed article is a shaped article.

In one embodiment, the three-dimensional printed article is selected from a medical device, human being body organ, animal body organ, toy, contact lens, rapid prototyping, automotive components, aerospace components, construction components, robotics, consumer goods, electronics components such as rectifiers, transistors, diodes, operational amplifiers, light-emitting diodes (LEDs), batteries, electrodes; wearables, cosmetics, entertainment device, decor items, art pieces, microfluidic device, designs or models in the field of construction, infrastructure, automotive, aerospace, healthcare; shoes, textile items, jewelry, house hold items, chip set, gasket, packaging, engine parts of a vehicle, gloves, cutlery.

In one embodiment, the composition has modulus of at least 0.04 Mega pascal.

In still another aspect, provided is a method of forming an article comprising subjecting a composition of in accordance with any of the previous embodiments to a three-dimensional printing process.

In one embodiment, the three-dimensional printing process employs a printer selected from stereolithography printer (SLA), digital light processing (DLP) printer, jet printer, Daylight Polymer Printing (DPP) printer, Fused deposition Modeling (FDM) printer, Selective Laser Sintering (SLS) printer, Selective Laser Melting (SLM) printer, Binder Jetting (BJ) printer and Material Jetting (MJ) printer.

In one embodiment, the composition has viscosity up to 50000 centipoise (cP).

In one embodiment, the composition has gel time up to 60 seconds at 25 mW/cm² power intensity of the radiation.

These and other aspects and embodiments of the invention are further described and illustrated with reference to the following detailed description.

### DETAILED DESCRIPTION

In the specification and claims herein, the following terms and expression are to be understood as having the hereinafter indicated meanings.

The singular forms “a,” “an” and “the” include the plural, and reference to a particular numerical value includes at least that particular value unless the context clearly dictates otherwise.

As used herein the term “aromatic” refers to a compound having a valence of at least one and comprising at least one aromatic ring. In embodiments, an aromatic group comprises a C6-C30 aromatic functional group. The aromatic compound can include multiple rings that may be joined by a bond or other linking group. The aromatic compound may also include aromatic groups having two or more fused rings. The term includes groups containing both aromatic and aliphatic components, for example a benzyl group, a phenethyl group or a naphthylmethyl group. The term also includes groups comprising both aromatic and cycloaliphatic groups for example 4-cyclopropylphenyl and 1,2,3,4-tetrahydronaphthalen-1-yl.

The term “alkyl” as used in the various embodiments of the present invention is intended to designate both normal alkyl, branched alkyl, aralkyl, and cycloalkyl radicals. In various embodiments normal and branched alkyl radicals are those containing from 1 to about 60 carbon atoms, and include as illustrative non-limiting examples methyl, ethyl, n-propyl, isopropyl, n-butyl, sec-butyl, tertiary-butyl, pentyl, neopentyl, hexyl, heptyl, octyl, nonyl, decyl, undecyl and dodecyl.

In various embodiments linear and branched alkyl radicals are those containing from 1 to about 60 carbon atoms and their isomers, and include as illustrative non-limiting examples methyl, ethyl, n-propyl, isopropyl, n-butyl, sec-butyl, tertiary-butyl, pentyl, neopentyl, hexyl, heptyl, octyl, nonyl, decyl, undecyl, and dodecyl.

The term “polymerization-effective polymer” refers to a monomer or pre-polymer or oligomer or copolymer or polymer that can be polymerized or further polymerized or copolymerized.

The term “organo-silicone” or “silicone containing polymer” refers to a polymer or resin comprising multiple organosiloxane or polyorganosiloxane groups per molecule. Organopolysiloxane is intended to include polymers substantially containing only organosiloxane or polyorganosiloxane groups in the polymer chain, and polymers where the backbone contains both organosiloxane and/or polyorganosiloxane groups and organic polymer groups in the polymer chain. Such polymers may be homopolymers or copolymers, including, for example, block copolymers and random copolymers. Organo-silicone is also intended to include resins having a three-dimensional cross-linked network.

The term heteroatoms include all atoms or elements listed in periodic table except carbon and hydrogen, whether or not explicitly mentioned in the specification and/or recited in a claim.

As used herein the term “aliphatic” refers to a group having a valence of at least one and consisting of a linear or branched array of atoms which is not cyclic. The array may include heteroatoms such as nitrogen, sulfur and oxygen or may be composed exclusively of carbon and hydrogen. Examples of aliphatic radicals include methyl, methylene, ethyl, ethylene, hexyl, hexamethylene and the like.

It will be understood that any numerical range recited herein includes all sub-ranges within that range and any combination of the various endpoints of such ranges or sub-ranges. Numerical values can be combined to form new and non-specified ranges.

As used herein, the terms “comprising,” “including,” “containing,” “characterized by” and grammatical equivalents thereof are inclusive or open-ended terms that do not exclude additional, unrecited elements or method steps, but will also be understood to include the more restrictive terms “consisting of” and “consisting essentially of”.

It will be further understood that any compound, material, or substance which is expressly or implicitly disclosed in the specification and/or recited in a claim as belonging to a group of structurally, compositionally, and/or functionally related compounds, materials or substances includes individual representatives of the group and all combinations thereof.

Other than in the working examples or where otherwise indicated, all numbers expressing amounts of materials, reaction conditions, time durations, quantified properties of materials, and so forth, stated in the specification and claims are to be understood as being modified in all instances by the term “about.”

All viscosity measurements referred to herein were measured at 25° C. unless otherwise indicated. In one embodiment, viscosity can be measured using a Haake-Rheostress oscillatory rheometer using a cone-and-plate attachment (1° angle) at a shear rate of 10 rad/s and a gap width of 0.050 mm optimized for this testing geometry.

Composition percentages are given in weight percent unless otherwise indicated.

The use of “for example” or “such as” to list illustrative examples does not limit to only the listed examples. Thus, “for example” or “such as” means “for example, but not limited to” or “such as, but not limited to” and encompasses other similar or equivalent examples.

In one embodiment, provided is an organo-silicone composition comprising:

a. up to 99 wt. %, based on the total weight of the composition, of at least one polymerization-effective silicone containing polymer bearing unsaturated hydrocarbon group;
b. up to 99 wt. %, based on the total weight of the composition, of at least one mercapto functional silicone resin of general formula (I):

M⁴ₖM⁵ₗD⁴ₘD⁵ₙT⁴ₒT⁵ₚQ¹ᵣ (I)

wherein, the M⁴ and M⁵ units are of the formula R²⁰R²¹R²²SiO_{1/2};
the D⁴ and D⁵ units are of the formula: R²³R²⁴SiO_{2/2};
the T⁴ and T⁵ units are of the formula: R²⁵SiO_{2/3};
the Q¹ units are of the formula SiO_{4/2};
R²⁰-R²⁵are independently chosen from hydrogen, a hydroxyl, a linear or branched alkyl group, an alcohol, a linear or branched alkoxy group, an aryl group, an alkylvinyl group, an amide, an amino-containing group, an acryloyl-containing group, a methacryloyl-containing group, a carbonyl-containing group, a silyloxy group, an isocyanate-containing group, a mercapto-containing group, an epoxy-containing group, where one or more of R²⁰-R²⁵ is a mercapto-containing group; k is from 0-1000,1 is from 0-1000; m is from 0-500; n is from 0-500; o is from 0-100; p is from 0-100; and r is from 0 to 200, provided at least two subscripts on any particular embodiment are positive integers and at least one of o or p should be a positive integer; and
c. a photo initiator;
wherein, the composition has a molar equivalent ratio of mercapto groups to unsaturated groups of up to 2.5.

It will be appreciated that terms such as “amino-containing group,” “acryloyl-containing group,” “methacryloyl-containing group,” “carbonyl-containing group,” “carboxylic acid-containing group,” “isocyanate-containing group,” “mercapto-containing group,” and “epoxy-containing group” refer to groups containing those respectively identified functional groups. They can be just the functional group themselves or a compound containing the functional group (e.g., a linker group terminated with that functional group or otherwise substituted somewhere in the compound with that functional group).

R²⁰-R²⁵ may be selected as desired for a particular purpose or intended application. For those R²⁰-R²⁵ groups that are not mercapto groups in the silicone resin (b), R²⁰-R²⁵ can be selected from those groups previously described. In embodiments, the non-mercapto R²⁰-R²⁵ are selected from a linear, branched, and/or cyclic C1-C20 alkyl, a C6-C10 aryl, or combinations of two or more thereof. In one embodiment, the non-mercapto R²⁰-R²⁵ groups are selected from a C1-C6 alkyl group.

As described herein, at least two subscripts selected from k, l, m, n, o, p, and r are positive integers provided that at least o or p is a positive integer. In one embodiment, k+l+m+n+o+p+r is 2 to 1000; in another embodiment k+l+m+n+o+p+r is 2 to 900, in another embodiment k+l+m+n+o+p+r is 2 to 800, in another embodiment k+l+m+n+o+p+r is 2 to 700; in another embodiment k+l+m+n+o+p+r is 2 to 600; in another embodiment, k+l+m+n+o+p+r is 2 to 500; in another embodiment, k+l+m+n+o+p+r is 2 to 400; in another embodiment, k+l+m+n+o+p+r is 2 to 300; in another embodiment, k+l+m+n+o+p+r is 2 to 200; and in another embodiment, k+l+m+n+o+p+r is 2 to 100.

In one embodiment, the silicone resin (b) is selected from an MDTQ resin, an MDT resin, an MT resin, or a TQ resin. In one embodiment, the silicone resin (b) is an MDT type structure. In such an embodiment, k+l is greater than 0, m+n is greater than 0, and o+p is greater than 0.

The mercapto containing group comprises a mercapto functional group, i.e., a —SH group. In one embodiment, the mercapto containing group is of the formula —(CH₂)ₜSH, where t is 0-10, 1-10, 2-8, 3-6, or 4-5. In one embodiment, t is 0. Examples of other suitable mercapto groups include, but are not limited to, mercaptomethyl, 2-mercaptoethyl, 3-mercaptoporpyl, 4-mercaptobutyl, etc.

The molar equivalent ratio of mercapto functional groups in silicone resin (b) to unsaturated groups in silicone resin (a) can be up to 2.5:1. In one embodiment, the molar equivalent ratio of mercapto functional groups to unsaturated groups in said composition is 2. In another embodiment, the molar equivalent ratio of mercapto functional groups to unsaturated groups in said composition is 1.5. In another embodiment, the molar equivalent ratio of mercapto functional groups to unsaturated groups in said composition is 1. In still another embodiment, the molar equivalent ratio of mercapto functional groups to unsaturated groups in said composition is 0.5. And in yet another embodiment, the molar equivalent ratio of mercapto functional groups to unsaturated groups in said composition is 0.1. In one embodiment, the molar equivalent ratio of mercapto functional groups from 0.1:1 to 2:1; from 0.5:1 to 1.5:1; from 0.75:1 to 1:1. In one embodiment, the molar equivalent ratio of mercapto functional groups in silicone resin (b) to unsaturated groups in silicone resin (a) is from 0.8:1 to 1.5:1.

In one embodiment, the silicone resin (b) is a MDT resin of the formula:

[(R²⁰)(R²¹)(R²²)SiO_{1/2}]ₖ[(R²⁵)SiO_{3/2}]ₒ[R²³R²⁴O_{2/2}]ₘ

where R²⁰, R²¹, R²², R²³, and R²⁴ are as described above, R²⁵ is —(CH₂)ₜSH, where t is 1-10, and k, and o, and m are positive integers. In one embodiment, R²⁰, R²¹, R²², R²³, and R²⁴ are each selected from a C1-C10 alkyl group, a C2-C8 alkyl group, or a C4-C6 alkyl group. In one embodiment, R²⁰, R²¹, R²², R²³, and R²⁴ are each methyl. In one embodiment k+o+m is from about 10 to about 300, from about 10 to about 200, or from about 10 to about 100.

The polymerization-effective silicone containing polymer bearing unsaturated hydrocarbon group is of general formula (II):

M¹ₐM²_{b}M³_{c}D¹_{d}D²ₑD³_{f}T¹_{g}T²ₕT³ᵢQⱼ (II)

wherein:
M¹=R¹R²R³SiO_{1/2}
M²=R⁴R⁵R⁶SiO_{1/2}
M³=R⁷R⁸R⁹SiO_{1/2}
D¹=R¹⁰R¹¹SiO_{2/2}
D²=R¹²R¹³SiO_{2/2}
D³=R¹⁴R¹⁵SiO_{2/2}
T¹=R¹⁶SiO_{3/2}
T²=R¹⁷SiO_{3/2}
T²=R¹⁸SiO_{3/2}
Q=SiO_{4/2}
   R¹ to R¹⁸ are independently selected from hydrogen, substituted or unsubstituted aliphatic, alicyclic, or aromatic containing hydrocarbon having from 1 to 60 carbon atoms optionally having a heteroatom, OR²⁶, or an unsaturated monovalent hydrocarbon optionally containing heteroatom(s) or a heteroatom such as oxygen, nitrogen, sulfur or containing organosilane groups; where R²⁶ is selected from hydrogen, substituted or unsubstituted aliphatic, alicyclic, or aromatic containing hydrocarbon having from 1 to 60 carbon; the subscript a, b, c, d, e, f, g, h, i, j are zero or positive integer provided 2≤a+b+c+d+e+f+g+h+i+j provided at least one of R¹-R¹⁸ is selected from unsaturated monovalent hydrocarbon or aromatic compound, having up to 60 carbon atoms optionally having a heteroatom or both.

The unsaturated group comprises at least one carbon-carbon double bond or a carbon-carbon triple bond. In one embodiment, the unsaturated group is an alkenyl group. The alkenyl group can be of the formula CH₂═CH₂—R²⁷ᵤ— where R²⁷ is a C1-C20 alkyl, a C1-C20 branched alkyl, a C1-C10 cyclic alkyl, or a C6-C10 aryl group, and u is 0 or 1. In one embodiment, the unsaturated group is chosen from vinyl, allyl, styryl, butenyl, pentenyl, hexenyl, etc.

In one embodiment, a+b+c+d+e+f+g+h+i+j is 2 to 10000, more preferably a+b+c+d+e+f+g+h+i+j is 5 to 9000, more preferably a+b+c+d+e+f+g+h+i+j is 10 to 8000, more preferably a+b+c+d+e+f+g+h+i+j is 15 to 7000 more preferably a+b+c+d+e+f+g+h+i+j is 15 to 6000, more preferably a+b+c+d+e+f+g+h+i+j is 15 to 5000, more preferably a+b+c+d+e+f+g+h+i+j is 15 to 4000, more preferably a+b+c+d+e+f+g+h+i+j is 15 to 3000, more preferably a+b+c+d+e+f+g+h+i+j is 15 to 2000, more preferably a+b+c+d+e+f+g+h+i+j is 15 to 1000, more preferably a+b+c+d+e+f+g+h+i+j is 25 to 1000, more preferably a+b+c+d+e+f+g+h+i+j is 15 to 1000, more preferably a+b+c+d+e+f+g+h+i+j is 5 to 1000.

The polymerization-effective silicone containing polymer bearing unsaturated hydrocarbon group (a) is present in an amount, from about 10% to 90% based on the total weight of the composition, preferably from about 20% to 80% based on the total weight of the composition, preferably from about 30% to 70% based on the total weight of the composition, preferably from about 40% to 60% based on the total weight of the composition, preferably from about 45% to 55% based on the total weight of the composition.

The mercapto functional silicone resin (b) is present in an amount from about 10% to 90% based on the total weight of the composition, preferably from about 20% to 80% based on the total weight of the composition, preferably from about 30% to 70% based on the total weight of the composition, preferably from about 40% to 60% based on the total weight of the composition, preferably from about 45% to 55% based on the total weight of the composition, preferably from about 15% to 35% based on the total weight of the composition, preferably from about 20% to 35% based on the total weight of the composition. In one embodiment, the mercapto functional silicone resin (b) is present in an amount of from about 1% to about 60% based on the total weight of the composition; from about 5% to about 50% based on the total weight of the composition; or from about 10% to about 45% based on the total weight of the composition.

The photo initiator (c) may be selected from any material suitable for promoting curing of the silicone resins (a) and (b). Examples of suitable photinitiators include but are not limited to, a benzophenone, a phosphine oxide, a nitroso compound, an acryl halide, a hydrazone, a mercapto compound, a pyrillium compound, a triacrylimidazole, a benzimidazole, a chloroalkyl triazine, a benzoin ether, a benzyl ketal, a thioxanthone, a camphorquinone, an acetophenone, an organometallic compound, a metallocene derivative, or a combination of two or more thereof.

Non-limiting examples of phototinitiators include those selected from acetophenone, propiophenone, 2-hydroxy-2-methylpropiophenone, 2,2-dimethoxy-1,2-diphenylethan-1-one (IRGACURE 651: available from BASF AG), 2-hydroxy-2-methyl-1-phenyl-propan-1-one (DAROCUR 1173: available from BASF AG), 1-hydroxy-cyclohexyl-phenyl-ketone (IRGACURE 184: available from BASF AG), 1-[4-(2-hydroxyethoxy)-phenyl]-2-hydroxy-2-methyl-1-propan-1-one (IRGACURE 2959: available from BASF AG), 2-hydroxy-1-{4-[4-(2-hydroxy-2-methyl-propionyl)-benzyl]phenyl}-2-methyl-propan-1-one (IRGACURE 127: available from BASF AG), 2-methyl-1-(4-methylthiophenyl)-2-morpholinopropan-1-one (IRGACURE 907: available from BASF AG), 2-benzyl-2-dimethylamino-(4-morpholinophenyl)-butanone-1 (IRGACURE 369: available from BASF AG), 2-(dimethylamino)-2-[(4-methylphenyl)methyl]-1-[4-(4-morpholinyl)phenyl]-1-butanone (IRGACURE 379: available from BASF AG), 2,4,6-trimethylbenzoyl-diphenyl-phosphonoxide (LUCIRIN TPO: available from BASF AG), bis(2,4,6-trimethylbenzoyl)-phenylphosphonoxide (IRGACURE 819: available from BASF AG), 2,4,6-trimethylbenzoyl-diphenyl phosphinate (LUCIRIN TPO-L: available from BASF AG), bis(2,6-difluoro-3-(1-hydropyrrol-1-yl)phenyl)titanocene (IRGACURE 784: available from BASF AG), 1,2-octanedione, 1-[4-(phenylthio)-, 2-(O-benzoyloxime)] (IRGACURE OXE 01: available from BASF AG), ethanone, 1-[9-ethyl-6-(2-methylbenzoyl)-9H-carbazol-3-yl]-, 1-(O-acetyloxime) (IRGACURE OXE 02: available from BASF AG), oxyphenylacetic acid, 2-[2-oxo-2-phenylacetoxy]ethoxylethylester and oxyphenylacetic acid, a mixture of 2-(2-hydroxyethoxy)ethyl esters (IRGACURE 754: available from BASF AG), Bis (4-methoxybenzoyl) diethylgermanium (Ivocerin: available from Ivoclar Vivadent, Schaan, Liechtenstein), phenylglyoxylic acid methyl ester (DAROCUR MBF: available from BASF AG), ethyl-4-dimethylaminobenzoate (DAROCUR EDB: available from BASF AG), 2-ethylhexyl-4-dimethylaminobenzoate (DAROCUR EHA: available from BASF AG), bis(2,6-dimethoxybenzoyl)-2,4,4-trimethyl-pentylphosphonoxide (CGI 403: available from BASE AG),benzoylperoxide, cumen peroxide, or combination thereof.

The photo initiator is present in an amount from 0.1% to 10% based on the total weight of the composition, preferably from about 0.5 to 5% based on the total weight of the composition, preferably from about 1% to 3%.

The organo-silicone composition of current invention may further comprise other additives or components as desired for a particular purpose or intended application and as may be suitable to provide a particular effect or property to the composition and/or the cured material formed from the composition. Examples of other materials or additives that may be included in the composition include, but are not limited to, UV absorbers, UV enhancers, photo inhibitors, reactive or non-reactive diluents, optical brighteners, adhesion promoters, fillers, radical stabilizers, diluents, coupling agents, coloring agents, antifoaming agents, defoaming agents, leveling agents, or a combination of two or more thereof.

The viscosity of the said organo-silicone composition of current invention is up to 50000 centipoise (cP), preferable from 5 to 40000 cP, more preferably 5 to 30000 cP, more preferably 5 to 20000 cP, more preferably 5 to 10000 cP, more preferably 5 to 5000 cP, more preferably 5 to 1000 cP. Viscosity is measure at 25 ° C. using a Haake-Rheostress oscillatory rheometer using a cone-and-plate attachment (1° angle) at a shear rate of 10 rad/s and a gap width of 0.050 mm optimized for this testing geometry.

In one embodiment, provided is a process for preparing an organo-silicone composition in accordance with the invention. The organo-silicone composition may be prepared by adding the various components (a), (b), and (c), along with any other desired additives or components, together and mixing them to form a mixture. The order of addition of the components is not particularly limited.

In one embodiment, the organo-silicone composition is prepare by mixing (a) 10 to 90 wt. %, based on the total weight of the composition, of at least one polymerization-effective silicone polymer bearing unsaturated hydrocarbon group; (b) 1 to 60 wt. %, based on the total weight of the composition, of at least one mercapto functional silicone resin of general formula (I); and (c) a photo initiator; to form a composition, wherein, the composition has a molar equivalent ratio of mercapto groups to unsaturated groups from 0.01 to 2.5.

The present organo-silicone compositions may be used in a printing process to form an article or to form a printed layer or feature on a substrate. The present organo-silicone compositions can be employed to form three-dimensional articles or layers/features. In three-dimensional printing, the substrate can be the printed composition itself that is cured or partially cured, or the substrate can be a surface upon which the printed three-dimensional article rests. The methods and process for three-dimensional printing are not particularly limited. Such methods will be known or available to those skilled in the art, and the specific details for printing a three-dimensional are not reproduced herein. In general, a three-dimensional article is printed by printing layers and curing them by exposure to an energy source that emits at least UV radiation, and adding layers successively to form a pre-determined shape. In one embodiment, The organo-silicone composition of said three-dimensional printed article is vat polymerized, where UV radiations of wavelength ranging from 300 to 780 nm is used for polymerization.

The gel time of the said organo-silicone composition of said three-dimensional printed article is up to 60 seconds at 25 mW/cm² power intensity of the radiation. In one embodiment, the gel time may be from 0.5 seconds to 60 seconds, 1 second to 45 seconds, 5 seconds to 30 seconds, or 10 to 25 seconds. In one embodiment, the gel time is from 0.5 to 3 seconds, 0.8 to 2.75 seconds, or 1 to 2 seconds.

The modulus of the printed article formed from printing the present compositions is at least 0.04 Megapascals (MPa), preferably 0.04 to 20 Megapascals, more preferably 0.04 to 10 Megapascals, more preferably 0.04 to 5 Megapascals, more preferably 0.04 to 1 Megapascals.

The three-dimensional printing process is not particularly limited and can be selected as desired for a particular purpose or intended application. Examples of suitable printing processes include, but are not limited to, those defined by ASTM F2792-12a including (i) “binder jetting” which is defined as “an additive manufacturing process in which a liquid bonding agent is selectively deposited to join powder materials;” (ii) “material extrusion” which is defined as “an additive manufacturing process in which material is selectively dispensed through a nozzle or orifice; ”(iii) “material jetting” is defined as “an additive manufacturing process in which droplets of build material are selectively deposited:” (iv) “vat polymerization” which is defined as “an additive manufacturing process in which liquid photopolymer in a vat is selectively cured by light-activated polymerization;” and (v) “stereolithography (SL)” which is defined as “a vat photopolymerization process used to produce parts from photopolymer materials in a liquid state using one or more lasers to selectively cure to a predetermined thickness and harden the material into shape layer upon layer.”

The type of three-dimensional printer can be selected as desired and as may be required to employ a particular type of printing process. Examples of suitable three-dimensional printers include, but are not limited to, stereolithography printer (SLA), digital light processing (DLP) printer, jet printer, Daylight Polymer Printing (DPP) printer, Fused deposition Modeling (FDM) printer, Selective Laser Sintering (SLS) printer, Selective Laser Melting (SLM) printer, Binder Jetting (BJ) printer and Material Jetting (MJ) printer.

The compositions can be processed by three-dimensional printing methods to form an article of any shape as desired for a particular purpose or intended application. In embodiments, the three-dimensional printed article of the current invention is a shaped article selected from a medical device, human being body organ, animal body organ, toy, contact lens, rapid prototyping, automotive components, aerospace components, construction components, robotics, consumer goods, electronics components such as rectifiers, transistors, diodes, operational amplifiers, light-emitting diodes (LEDs), batteries, electrodes; wearables, cosmetics, entertainment device, décor items, art pieces, microfluidic device, designs or models in the field of construction, infrastructure, automotive, aerospace, healthcare; shoes, textile items, jewelry, house hold items, chip set, gasket, packaging, engine parts of a vehicle, gloves, cutlery.

In yet another embodiment, the three-dimensional printer uses photocurable material as ink to print.

### EXAMPLES

### Methods

The curing profile or gel time of the organo-silicone composition was measured by time resolved photo cure profile and was measured using DHR-3 rheometer with UV curing accessories. The accessory uses a light guide and reflecting mirror assembly to transfer UV radiation from a high-pressure mercury light source. The UV intensity was calibrated as 25 mW/cm² on the sample placed between two 20 mm parallel plates assuming a thickness of 300 μm. At the UV source a band pass filter of window slit of λ=400-500 nm was used.

The UV curing was probed in oscillatory rheology mode using a time sweep in linear viscoelastic region of the cured Resin. The cure time is correlated with the gel point which is defined as the time when G′(storage modulus)=G″ (loss modulus) at 1 Hz oscillatory frequency.

The viscosity of the organo-silicone composition was measured using a Haake-Rheostress oscillatory rheometer using a cone-and-plate attachment (1° angle) and a gap width of 0.050 mm optimized for this testing geometry.

### Example 1

An organo-silicone composition was made by mixing employing a Hauschild Speed Mixer DAC 600 FVZ at 1000 to 2350 rpm for 2 to 10 minutes using 63.2% of a vinyl-terminated polymethylphenylsiloxane with vinyl unit of 0.12 mmol/g (Vinyl-1), 11.2% of Vinyl functionalized silicone polymer containing Q group with vinyl content of 1.06 mmol/g (Vinyl-2), 24.2% of mercapto functional silicone resin (MDT type) with mercapto content of 0.98 mmol/g (SH-1), and 1.5% of photo initiator.

### Example 2

The organo-silicone compositions were made by the same way as example 1 using materials as listed in Table 1.

### Example 3 to 4

The organo-silicone compositions were made by the same way as example 1 additionally using SMS-042 is [4-6% (mercaptopropyl)methylsiloxane]-dimethylsiloxane copolymer sourced from Gelest Inc, as listed in Table 1.

### Comparative Example 1 and 2

The organo-silicone compositions of comparative example 1 does not contain mercapto functional silicone resin SH-1 but only SMS-042 and is made in the similar method as example 1 according to materials listed in Table 1

The organo-silicone compositions of comparative example 2 contain mercaptopropyl trimethoxysilane (A-189) instead of mercapto functional silicone resin SH-1 and/or SMS-042 used in examples 1 to 4 and is made in the similar method as example 1 according to materials listed in Table 1

TABLE 1

| | Comparative | Comparative | | | | |
|---|---|---|---|---|---|---|
| | Example 1 | Example 2 | Example 1 | Example 2 | Example 3 | Example 4 |
| Vinyl-1 | 33.3 | 78.9 | 63.2 | 45.9 | 60.5 | 44.7 |
| Vinyl-2 | 5.9 | 13.9 | 11.2 | 8.1 | 10.7 | 7.9 |
| SH-1 | 0 | | 24.2 | 41.2 | 15.6 | 27.9 |
| SMS-042 | 55.9 | | — | — | 11.8 | 14.8 |
| A-189 | | 5.7 | | | | |
| EHA* | 3.5 | | — | 3.4 | — | 3.3 |
| Photo | 1.5 | 1.5 | 1.5 | 1.5 | 1.5 | 1.5 |
| initiator^{#} | | | | | | |
| (%) | | | | | | |
| SH/ | 1.2 | 1.3 | 1.2 | 1.3 | 1.2 | 1.2 |
| unsaturation | | | | | | |
| Viscosity | 270 | 960 | 570 | 440 | 420 | 760 |
| (cP) | | | | | | |
| Gel time | 6.9 | | 0.9 | 1.9 | 1.3 | 2.6 |
| (Sec) | | | | | | |
| G’ (Pa)^{@} | 13000 | | 213000 | 67000 | 224000 | 67000 |
| Form of | Soft gel | Viscous | Elastomeric | Soft Solid | Elastomeric | Soft solid |
| cured article | | liquid | solid | | solid | |

*EHA = 2-ethylhexyl acrylate
^{#}photo-initiator is blend of 75 parts of 2-hydroxy-2-methyl-1-phenyl-propan-1-one, 30 parts of 2,4,6-trimethylbenzoyl-diphenyl-phosphine oxide and 25 parts of bis(2,4,6-trimethylbenzoyl)-phenylphosphine oxide, all sourced from Aldrich
^{@}One Mega pascal is equal to 10⁶ Pascal (Pa)

Table 2 summarizes examples of UV curable compositions and their properties. The compositions (Comparative examples 3, 4 and examples 5-10) were made by mixing ingredients as mentioned in Table 2, following the method described in example 1, where Vinyl-3 is vinyl-terminated polymethylphenylsiloxane with vinyl content of 0.069 mmol/g, Si-MA-1 is polydimethylsiloxane having terminal ethyl hydroxycyclohexyl methacrylate units and consisting of approximately 25 condensed dimethylsiloxy units and silica is silanamine, 1,1,1-trimethyl-N-(trimethylsilyl)-, hydrolysis products with silica sourced from Evonik. The silica is added in the composition as a preblend in vinyl-terminated polymethylphenylsiloxane. The composition is cured in Teflon mold of 2mm depth by irradiating UV curing chamber from XYZ printing equipped with 375-405 nm UV LED system for up to 30 min.

TABLE 2

| | Comparative | Comparative | | | | | | |
|---|---|---|---|---|---|---|---|---|
| | Example 3 | Example 4 | Example 5 | Example 6 | Example 7 | Example 8 | Example 9 | Example 10 |
| Vinyl-1 | 53.5 | 75.9 | 62.6 | 60.7 | 72.4 | | | 1.7 |
| Vinyl-2 | 9.7 | 13.1 | 11 | 10.6 | | | | 1.2 |
| Vinyl-3 | | | | | | 66.7 | 70.9 | 67.5 |
| Si-MA-1 | | | | | | 15.3 | 13.4 | 11.6 |
| SH-1 | | | 23.8 | 23.1 | 16.8 | 15.7 | 11.7 | 14.1 |
| SMS-042 | 31.4 | | | | | | | |
| A-189 | | 5.5 | | | | | | |
| Silica | 5.1 | 5.1 | 2 | 5.3 | 10.3 | 1.6 | 3.5 | 3.3 |
| Photo | 0.3 | 0.3 | 0.5 | 0.3 | 0.5 | 0.5 | 0.5 | 0.4 |
| initiator^{#$} | | | | | | | | |
| (%) | | | | | | | | |
| SH/ | 1.35 | 1.35 | 1.35 | 1.35 | 1.89 | 0.87 | 0.70 | 0.88 |
| unsaturation | | | | | | | | |
| Viscosity | 1.2 | 2.0 | 1.1 | 1.5 | 3.4 | 3.1 | 5 | 4.7 |
| (Pa.s) | | | | | | | | |
| Tensile | 0.28 | Viscous | 0.4 | 0.7 | 0.5 | 0.74 | 1.4 | 0.75 |
| strength | | fluid | | | | | | |
| (MPa) | | | | | | | | |
| Elongation | 58 | | 83 | 108 | 157 | 135 | 195 | 127 |
| (%) | | | | | | | | |
| Hardness | 17 | | 31 | 31 | 21 | | 25 | |
| (Shore A) | | | | | | | | |

^{#}photo-initiator is blend of 81 parts of bis(2,4,6-trimethylbenzoyl)-phenylphosphine oxide and 819 parts of Ethyl (2,4,6-trimethylbenzoyl)phenylphosphinate (sourced from Molway) and 100 parts of 2-(2H-Benzotriazol-2-yl)-4,6-di-tert-pentylphenol as UV absorber (sourced from Aldrich).
^{$}Comparative examples 3, 4 and examples 5-7 have ~100 ppm of 4-Methoxyphenol (sourced from Aldrich) and examples 8-10 have ~280 ppm of butylated hydroxytoluene as inhibitor (sourced from Aldrich)

The 3D printing of organo-silicone compositions was done in Nobel Superfine 3D printer from XYZ Printing. This is done by sequentially projecting radiation to the composition taken in a vat to cure layer by layer leading to the 3D article (green state). The 3D printed article is washed to remove excess material and irradiated further to complete the printing process.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

1. An organo-silicone composition comprising:
a. 10 to 90 wt. %, based on the total weight of the composition, of at least one polymerization-effective silicone containing polymer bearing unsaturated hydrocarbon group;
b. 1 to 60 wt. %, based on the total weight of the composition, of at least one mercapto functional silicone resin of general formula (I);
M⁴ₖM⁵ₗD⁴ₘD⁵ₙT⁴ₒT⁵ₚQ¹ᵣ (I)
Wherein, the M⁴ and M⁵ units are of the formula R²⁰R²¹R²² SiO_{1/2};
the D⁴ and D⁵ units are of the formula: R²³R²⁴SiO_{2/2};
the T⁴ and T⁵ units are of the formula: R²⁵SiO_{3/2};
the Q¹ units are of the formula SiO_{4/2};
R²⁰-R²⁵ are independently chosen from hydrogen, a hydroxyl, a linear or branched alkyl group, an alcohol, a linear or branched alkoxy group, an aryl group, an alkylvinyl group, an amide, an amino-containing group, an acryloyl-containing group, a methacryloyl-containing group, a carbonyl-containing group, a carboxylic acid-containing group, a silyloxy group, an isocyanate-containing group, a mercapto-containing group, an epoxy-containing group, where one or more of R²⁰—R²⁵ is a mercapto-containing group; k is from 0-1000, 1 is from 0-1000; m is from 0-500; n is from 0-500; o is from 0-100; p is from 0-100; and r is from 0 to 200, provided at least two subscripts on any particular embodiment are positive integers and at least one of o or p should be a positive integer;
and
c. a photo initiator;
wherein, the composition has a molar equivalent ratio of mercapto functional groups to unsaturated groups from 0.01 to 2.5.

2. The organo-silicone composition of claim 1, wherein the molar equivalent ratio of mercapto functional groups to unsaturated groups is 0.1:1 to 2:1.

3. The organo-silicone composition of claim 1, wherein the molar equivalent ratio of mercapto functional groups to unsaturated groups is 0.8 to 1.5:1.

4. The organo-silicone composition of claim 1, wherein at least one polymerization-effective silicone containing polymer bearing unsaturated hydrocarbon group is of general formula (II)
M¹ₐM²_{b}M³_{c}D¹_{d}D²ₑD³_{f}T¹_{g}T²ₕT³ᵢQⱼ (II)
wherein:
M¹=R¹R²R³SiO_{1/2}
M²=R⁴R⁵R⁶SiO_{1/2}
M³=R⁷R⁸R⁹SiO_{1/2}
D¹=R¹⁰R¹¹SiO_{2/2}
D²=R¹²R¹³SiO_{2/2}
D³=R¹⁴R¹⁵SiO_{2/2}
T¹=R¹⁶SiO_{3/2}
T²=R¹⁷SiO_{3/2}
T³=R¹⁸SiO_{3/2}
Q=SiO_{4/2}
R¹ to R¹⁸ are independently selected from hydrogen, substituted or unsubstituted aliphatic, alicyclic, or aromatic containing hydrocarbon having from 1 to 60 carbon atoms optionally having a heteroatom, OR²⁶, or an unsaturated monovalent hydrocarbon optionally containing heteroatom(s) or a heteroatom such as oxygen, nitrogen, sulfur or containing organosilane groups; where R²⁶ is selected from hydrogen, substituted or unsubstituted aliphatic, alicyclic, or aromatic containing hydrocarbon having from 1 to 60 carbon; the subscript a, b, c, d, e, f, g, h, i, j are zero or positive integer provided 2≤a+b+c+d+e+f+g+h+i+j provided at least one R group is selected from unsaturated monovalent hydrocarbon or aromatic compound, having up to 60 carbon atoms optionally having a heteroatom or both.

5. The organo-silicone composition of claim 1 wherein the photo initiator is selected from a benzophenone, a phosphine oxide, a nitroso compound, an acryl halide, a hydrazone, a mercapto compound, a pyrillium compound, a triacrylimidazole, a benzimidazole, a chloroalkyl triazine, a benzoin ether, a benzyl ketal, a thioxanthone, a camphorquinone, an acetophenone, an organometallic compound, a metallocene derivative, or a combination of two or more thereof.

6. The organo-silicone composition of claim 1, further comprising a UV absorber, a UV enhancer, a photo inhibitor, a reactive or non-reactive diluent, an optical brightener, an adhesion promoter, a filler, a radical stabilizer, a diluent, a coupling agent, a coloring agent, an antifoaming agent, a defoaming agents, a leveling agent, or combination of two or more thereof.

7. The organo-silicone composition of claim 1, comprising the polymerization-effective silicone polymer (a) in an amount of from about 20% to 80% based on the total weight of the composition, and the mercapto functional silicone resin (b) is present in an amount of from about 5% to about 50% based on the total weight of the composition.

8. The organo-silicone composition of claim 1, wherein the mercapto functional silicone resin (b) is a MDT resin where k+l is greater than 0, m+n is greater than 0, and o+p is greater than 0.

9. A process to prepare an organo-silicone composition comprising mixing:
a. 10 to 90 wt. %, based on the total weight of the composition, of at least one polymerization-effective silicone polymer bearing unsaturated hydrocarbon group;
b. 1 to 60 wt. %, based on the total weight of the composition, of at least one mercapto functional silicone resin of general formula (I);
M⁴ₖM⁵₁D⁴ₘD⁵ₙT⁴ₒT⁵ₚQ¹ᵣ (I)
Wherein, the M⁴ and M⁵ units are of the formula R²⁰R²¹R²²SiO_{1/2};
the D⁴ and D⁵ units are of the formula: R²³R²⁴SiO_{2/2};
the T⁴ and T⁵ units are of the formula: R²⁵SiO_{3/2};
the Q¹ units are of the formula SiO_{4/2};
R²⁰ —R²⁵ are independently chosen from hydrogen, a hydroxyl, a linear or branched alkyl group, an alcohol, a linear or branched alkoxy group, an aryl group, an alkylvinyl group, an amide, an amino-containing group, an acryloyl-containing group, a methacryloyl-containing group, a carbonyl-containing group, a carboxylic acid-containing group, a silyloxy group, an isocyanate-containing group, a mercapto-containing group, an epoxy-containing group, where one or more of R²⁰—²⁵ is a mercapto-containing group; k is from 0-1000, 1 is from 0-1000; m is from 0-500; n is from 0-500; o is from 0-100; p is from 0-100; and r is from 0 to 200, provided at least two subscripts on any particular embodiment are positive integers and at least one of o or p should be a positive integer; and
c. a photo initiator; to form a composition,
wherein, the composition has a molar equivalent ratio of mercapto groups to unsaturated groups from 0.01 to 2.5.

10. The process to prepare an organo-silicone composition of claim 9, wherein the molar equivalent ratio of mercapto groups to unsaturated groups is 0.1:1 to 2:1.

11. The process to prepare an organo-silicone composition of claim 9, wherein the molar equivalent ratio of mercapto groups to unsaturated groups is 0.8 to 1.5:1.

12. The process to prepare an organo-silicone composition of claim 9, wherein at least one polymerization-effective silicone polymer bearing unsaturated hydrocarbon group is of general formula (II)
M¹ₐM²_{b}M³_{c}D¹_{d}D²_{c}D³_{f}T¹_{g}T²ₕT³ᵢQⱼ (II)
wherein:
M¹=R¹R²R³SiO_{1/2}
M²=R⁴R⁶R⁶SiO_{1/2}
M³=R⁷R⁸R⁹SiO_{1/2}
D¹=R¹⁰R¹¹SiO_{2/2}
D²=R¹²R¹³SiO_{2/2}
D³=R¹⁴R¹⁵SiO_{2/2}
T¹=R¹⁶SiO_{3/2}
T²=R¹⁷SiO_{3/2}
T³=R¹⁸SiO_{3/2}
Q=SiO_{4/2}
R¹ to R¹⁸ are independently selected from hydrogen, substituted or unsubstituted aliphatic, alicyclic, or aromatic containing hydrocarbon having from 1 to 60 carbon atoms optionally having a heteroatom, OR²⁶, or an unsaturated monovalent hydrocarbon optionally containing heteroatom(s) or a heteroatom such as oxygen, nitrogen, sulfur or containing organosilane groups; where R²⁶ is selected from hydrogen, substituted or unsubstituted aliphatic, alicyclic, or aromatic containing hydrocarbon having from 1 to 60 carbon; the subscript a, b, c, d, e, f, g, h, i, j are zero or positive integer provided 2≤a+b+c+d+e+f+g+h+i+j provided at least one R group is selected from unsaturated monovalent hydrocarbon or aromatic compound, having up to 60 carbon atoms optionally having a heteroatom or both.

13. The process to prepare an organo-silicone composition of claim 9, wherein the photo initiator is selected from a benzophenone, a phosphine oxide, a nitroso compound, an acryl halide, a hydrazone, a mercapto compound, a pyrillium compound, a triacrylimidazole, a benzimidazole, a chloroalkyl triazine, a benzoin ether, a benzyl ketal, a thioxanthone, a camphorquinone, an acetophenone, an organometallic compound, a metallocene derivative, or a combination of two or more thereof.

14. The process to prepare an organo-silicone composition of claim 9 , further comprising mixing one or more of a UV absorber, a UV enhancer, a photo inhibitor, a reactive or non-reactive diluent, an optical brightener, an adhesion promoter, a filler, a radical stabilizer, a diluent, a coupling agent, a coloring agent, an antifoaming agent, a defoaming agents, a leveling agent, or combination of two or more thereof with components (a)-(c).

15. A three-dimensional printed article prepared from a composition of claim 1.

16. The three-dimensional printed article of claim 15, wherein said composition is polymerized using vat photopolymeriztion,binder jetting, or material jetting.

17. The three-dimensional printed article of claim 16, wherein said vat polymerization comprises exposing the composition to ultraviolet light of a wavelength of from 300 to 780 nm.

18. The three-dimensional printed article of claim 15, wherein the article is a shaped article.

19. The three-dimensional printed article of claim15, wherein the article, is selected from a medical device, human being body organ, animal body organ, toy, contact lens, rapid prototyping, automotive component, aerospace component, construction components, robotic, consumer good, electronics component selected from a rectifier, transistor, diode, operational amplifier, light-emitting diode (LED), battery, electrode; a wearable, a cosmetic, an entertainment device, a decor item, an art piece, a microfluidic device, a design or model in the field of construction, infrastructure, automotive, aerospace, or healthcare;
a shoe, a textile item, jewelry, a house hold item, a chip set, a gasket, packaging, an engine part of a vehicle, a glove, or cutlery.

20. The three-dimensional printed article of claim 15, wherein said composition has modulus of at least 0.04 Mega pascal.

21. A method of forming an article comprising subjecting a composition of claim 1 to a three-dimensional printing process.

22. The method of claim 21, wherein the three-dimensional the three-dimensional printing process employs a printer selected from stereolithography printer (SLA), digital light processing (DLP) printer, jet printer, Daylight Polymer Printing (DPP) printer, Fused deposition Modeling (FDM) printer, Selective Laser Sintering (SLS) printer, Selective Laser Melting (SLM) printer, Binder Jetting (BJ) printer and Material Jetting (MJ) printer.

23. The method of claim 21, wherein said composition has viscosity up to 50000 centipoise (cP).

24. The method of claim 21, wherein said composition has gel time up to 60 seconds at 25 mW/cm² power intensity of the radiation.
